(19) United States
(12) Patent Application Publication
(10) Pub. No.: US 2007/0057421 A1
(43) Pub. Date: Mar. 15, 2007

(54) Fluid filled type vibration damping device

(75) Inventors: Takanobu Nanno, Kasugai-shi (JP); Hiroyuki Ichikawa, Kani-shi (JP); Yoshinori Watanabe, Inuyama-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., KOMAKI-SHI (JP)

(21) Appl. No.: 11/521,510

(22) Filed: Sep. 15, 2006

(30) Foreign Application Priority Data
Sep. 15, 2005 (JP) 2005-269063

(51) Int. Cl. F16F 13/00

(52) U.S. Cl. 267/140.13; 267/140.11

(57) ABSTRACT

A fluid filled type vibration damping device having: a first and a second mounting member linked by a rubber elastic body; a pressure-receiving chamber partially defined by the rubber elastic body with a non-compressible fluid sealed therein; an equilibrium chamber partially defined by a flexible film with the non-compressible fluid sealed therein; a first orifice passage connecting between the pressure-receiving and equilibrium chambers; and a rigid septum member partitioning the pressure-receiving chamber into a first pressure-receiving section partially defined by the main rubber elastic body and a second pressure-receiving section partially defined by a displaceable fluid pressure adjustment member. The two pressure-receiving sections communicate together via through-holes formed through the septum member, which constitute a second orifice passage tuned higher than the first orifice passage.

### INCORPORATED BY REFERENCE

The disclosure of Japanese Patent Application No. 2005-269063 filed on Sep. 15, 2005 including the specification, drawings and abstract is incorporated herein by reference in its entirety.

### BACKGROUND OF THE INVENTION

1. Field of the Invention

The present invention pertains to a sealed fluid vibration damping device designed to produce vibration damping action based on the flow behavior of a non-compressible fluid sealed therein, and relates in particular to a fluid filled type vibration damping device suitable for use as an automotive engine mount or the like, for example.

2. Description of the Related Art

There is known vibration damping devices each including a first mounting member and second mounting member connected by a main rubber elastic body, which have been employed in various fields as vibration damping couplings or vibration damped supports for installation between components that make up a vibration transmission system. As one such type of device, there has been proposed a fluid filled vibration damping device comprising: a first mounting member and a second mounting member connected by a main rubber elastic body; a pressure-receiving chamber a portion of whose wall is constituted by the rubber elastic body and that gives rise to pressure fluctuations during vibration input across the first mounting member and second mounting member; an equilibrium chamber a portion of whose wall is constituted by a flexible film and that readily permits change in volume based on deformation of the flexible film, having a non-compressible fluid sealed within the pressure-receiving chamber and the equilibrium chamber; and an orifice passage through which the pressure-receiving chamber and equilibrium chamber communicating with one another (see JP-A-2003-74617).

In this kind of sealed fluid vibration damping device, vibration damping action can be obtained by utilizing the flow action, such as resonance action, of the non-compressible fluid sealed within it. Additionally, low dynamic spring effect and high attenuating effect on a level not obtainable with the vibration damping action of the main rubber elastic body alone can be readily achieved in the tuning frequency band. Consequently, fluid filled vibration damping devices of the kind described above has been applied to automotive engine mounts and body mounts in which high vibration damping abilities in particular frequency bands is required.

In fluid filled type vibration damping devices of this kind, the problem of noise and vibration produced when large shocking vibration load is input across the first mounting member and the second mounting member has been pointed out. For example, where a fluid filled type vibration damping device is employed in an automotive engine mount, such noise and vibration has been found to occur when driving over bumps or the like.

The occurrence of such noise and vibration is attributed to a phenomenon whereby during input of large shocking vibration load, gases separate from the sealed fluid due to the large change in fluid pressure produced in the pressure-receiving chamber, with the gases subsequently redissolving in the sealed fluid.

The phenomenon of gas separating from the sealed fluid (i.e. the occurrence of cavitation bubbles) has been found to occur readily in the connecting portion of the pressure-receiving chamber and the orifice passage. This is thought to be caused by sudden sharp change in the flow of sealed fluid in the connecting portion of the pressure-receiving chamber and the orifice passage, resulting in a large change in fluid pressure.

The issue of how to prevent sharp change in the flow of sealed fluid in the connecting portion of the pressure-receiving chamber and the orifice passage to avoid large changes in fluid pressure is under study. However, it is difficult to obtain satisfactory results with this approach in isolation.

It has also been contemplated to lower the pressure-receiving chamber wall spring rigidity in order to enable change in fluid pressure occurring in the pressure-receiving chamber to be absorbed. However, this cannot be considered as an effective measure, since it suffers from an associated problem, namely, a deterioration of vibration damping action based on resonance behavior or other flow behavior of fluid caused to flow through the orifice passage.

### SUMMARY OF THE INVENTION

It is therefore an object of the present invention to provide a fluid filled type vibration damping device of novel construction able to suppress the occurrence of noise and vibration caused by redissolving into the sealed fluid of gases that have separated from the sealed fluid, while at the same time ensuring vibration damping effect based on resonance action or other flow action of fluid caused to flow through the orifice passage.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the present invention provides a fluid filled type vibration damping device comprising: a first mounting member; a second mounting member; a main rubber elastic body elastically connecting the first and second mounting members; a pressure-receiving chamber whose wall is partially defined by the main rubber elastic body, and having a non-compressible fluid sealed therein; an equilibrium chamber whose wall is partially defined by a flexible film, and having the non-compressible fluid sealed therein; a first orifice passage through which the pressure-receiving chamber and equilibrium chamber communicate with each other; and a rigid septum member partitioning the pressure-receiving chamber into a first pressure-receiving section and a second pressure-receiving section, with the first pressure-receiving section being partially defined by the main rubber elastic body, and the second pressure-receiving section being partially defined by a displaceable fluid pressure adjustment member, wherein the first orifice passage is open to the second pressure-receiving section of the pressure-receiving chamber so that the second pressure-receiving section communicates with the equilibrium chamber through the first orifice passage, while the second pressure-receiving section communicates with the first pressure-receiving section through a plurality of through-holes formed through the septum member, and the plurality of through-holes constituting a second orifice passage tuned to a higher frequency band than the first orifice passage.

In the fluid filled type vibration damping device of construction in accordance with this mode, the first pressure-receiving section is partially defined by the rubber elastic body, while the second pressure-receiving section is partially defined by the displaceable fluid pressure adjustment member, and communicates with the equilibrium chamber through the first orifice passage. These first and second pressure-receiving sections communicate with each other through the plurality of through-holes formed in the septum member that divides the first pressure-receiving section from the second pressure-receiving section. Therefore, in the event when large shocking vibration load is input, a large change in fluid pressure occurs within the pressure-receiving chamber, and bubbles are generated at the opening of the first orifice passage towards the second pressure-receiving section side, the generated bubbles will pass through the through-holes formed in the septum member, and move towards the main rubber elastic body, i.e. the first pressure-receiving section.

Accordingly, in this mode, by appropriately establishing the number, size, and locations of the plurality of through-holes formed in the septum member, it is possible to finely disperse formed bubbles as they pass through the through-holes. With this arrangement, it is possible for the bubbles to be in a finely dispersed state when they burst. As a result, it is possible to reduce overall noise and vibration produced by bursting bubbles.

Specifically, the magnitude of noise and vibration caused by bursting bubbles is related to the size of the bubbles when they burst, and it has been found that the larger bubbles are, the greater will be the noise and vibration produced when they burst. In this mode, since the bubbles have been finely dispersed by the time that they burst, it is possible to minimize noise and vibration caused by bursting of individual bubbles per se, and additionally to stagger the timing at which individual bubbles burst. Consequently, in this mode, it is possible to achieve an overall reduction in noise and vibration caused by bursting of bubbles.

The effect of this mode is not to suppress the formation of bubbles per se, but rather to finely disperse bubbles which have formed in order to reduce their size at the time they burst. Accordingly, there is no need to lower the pressure-receiving chamber wall spring rigidity in order to enable change in fluid pressure occurring in the pressure-receiving chamber to be absorbed. With this arrangement, it is possible to advantageously ensure vibration damping effect based on resonance action or other flow action of fluid caused to flow through the first orifice passage.

Additionally, in this mode, since part of the wall of the second pressure-receiving section is constituted by a displaceable fluid pressure adjustment member, it is possible to effectively inhibit high dynamic spring behavior in a higher frequency band than the tuning frequency of the first orifice passage.

In particular, in this mode, a plurality of through-holes formed in the septum member constitute a second orifice passage tuned to a higher frequency band than the first orifice passage, so that where for example the fluid pressure adjustment member is composed of movable rubber capable of elastic deformation, it becomes possible to obtain passive vibration damping action based on resonance behavior or other flow behavior of fluid caused to flow through the second orifice passage during input of vibration in a higher frequency band than the tuning frequency of the first orifice passage. By means of this arrangement, it is possible to improve vibration damping ability with respect to vibration in a higher frequency band than the tuning frequency of the first orifice passage. Also, the fluid pressure adjustment member may be composed of an excitation member capable of excited displacement by exciting device. In this arrangement, by tuning the second orifice passage to a frequency band slightly higher than the frequency band of the vibration intended to be damped, when the excitation member undergoes excited displacement the pressure fluctuation component of higher frequency than the tuning frequency band is not transmitted from the second pressure-receiving section to the first pressure-receiving section, it becomes possible to advantageously obtain dynamic vibration damping action based on excited displacement by the excitation member (fluid pressure adjustment member).

A second mode of the invention provides a fluid filled type vibration damping device according to the first mode wherein the fluid pressure adjustment member is composed of movable rubber disposed so as to be elastically deformable with respect to the second mounting member. In the fluid filled type vibration damping device of construction in accordance with this mode, it is possible to obtain passive vibration damping action through flow of fluid through the second orifice passage permitted by means of elastic deformation of the movable rubber.

A third mode of the invention provides a fluid filled type vibration damping device according to the first mode, wherein the fluid pressure adjustment member comprises a displaceably arranged excitation member, and an exciting device is provided for the purpose of exciting actuation of the excitation member. In the fluid filled type vibration damping device of construction according to this mode, pressure fluctuations in the second pressure-receiving section produced on the basis of displacement of the excitation member actuated by the exciting device is transmitted to the first pressure-receiving section through the second orifice passage. This makes it possible to obtain active or dynamic vibration damping effect by means of active control of pressure in the first pressure-receiving section.

In this mode, the second orifice passage may be tuned to a frequency band slightly higher than the frequency band of the vibration intended to be damped. With this arrangement, when the excitation member undergoes excited displacement, the pressure fluctuation component of higher frequency than the tuning frequency band will not be transmitted from the second pressure-receiving section to the first pressure-receiving section, making it possible to advantageously obtain dynamic vibration damping action based on excited displacement by the excitation member.

A fourth mode of the invention provides a fluid filled type vibration damping device according to any of the first to third modes wherein the first orifice passage is tuned to an engine shake frequency band, while the second orifice passage is tuned to a frequency band ranging from an idling vibration frequency to a booming noise frequency. The fluid filled type vibration damping device of construction in accordance with this mode can be employed appropriately as an automotive engine mount.

A fifth mode of the invention provides a fluid filled type vibration damping device according to any of the first to fourth modes wherein the second mounting member is a tubular body that has a first opening arranged on a side of the first mounting member and provided with a fluid-tight closure by means of the main rubber elastic body, and has an other opening provided with a fluid-tight closure by means of the flexible film, and wherein a partition member is disposed between opposing faces of the main rubber elastic body and the flexible film and supported by the second mounting member to thereby form the pressure-receiving chamber on one side thereof while forming the equilibrium chamber on an other side thereof, and wherein the partition member is utilized to form the first orifice passage, and the first orifice passage opens onto the pressure-receiving chamber at an outside peripheral edge of the partition member, while the through-holes constituting the second orifice passage are formed in the center portion of the septum member. With this arrangement, it is possible to form the pressure-receiving chamber and the equilibrium chamber with good space efficiency.

As will be apparent from the preceding description, in the fluid filled type vibration damping device constructed according to the present invention, a plurality of through-holes are formed in the septum member which divides the first pressure-receiving section partially defined by the rubber elastic body and the second pressure-receiving section that communicates with the equilibrium chamber through the first orifice passage. Accordingly, in the event when large shocking vibration load is input and a large fluctuation in fluid pressure in the pressure-receiving chamber is produced so that bubbles form in the opening of the first orifice passage to the second pressure-receiving section side, these bubbles will pass through the through-holes formed in the septum member, as the move towards the first pressure-receiving section side. It is possible thereby for the formed bubbles to be finely dispersed. As a result, it is possible to minimize noise and vibration caused by bursting of individual bubbles per se, and additionally to stagger the timing at which individual bubbles burst. Consequently, in the fluid filled type vibration damping device constructed according to this mode, it is possible to achieve an overall reduction in noise and vibration caused by bursting of bubbles.

### BRIEF DESCRIPTION OF THE DRAWINGS

The foregoing and/or other objects features and advantages of the invention will become more apparent from the following description of a preferred mode with reference to the accompanying drawings in which like reference numerals designate like elements and wherein:

FIG. 1 is an elevational view in vertical or axial cross section of a fluid filled vibration damping device in the form of an automotive engine mount of construction according to a first embodiment of the invention;

FIG. 2 is a top plane view of a septum member of the engine mount shown in FIG. 1;

FIG. 3 is a elevational view in vertical or axial cross section of an automotive engine mount of construction according to a second embodiment of the invention; and

FIG. 4 is a top plane view of a septum member of the engine mount shown in FIG. 3.

### DETAILED DESCRIPTION OF PREFERRED EMBODIMENTS

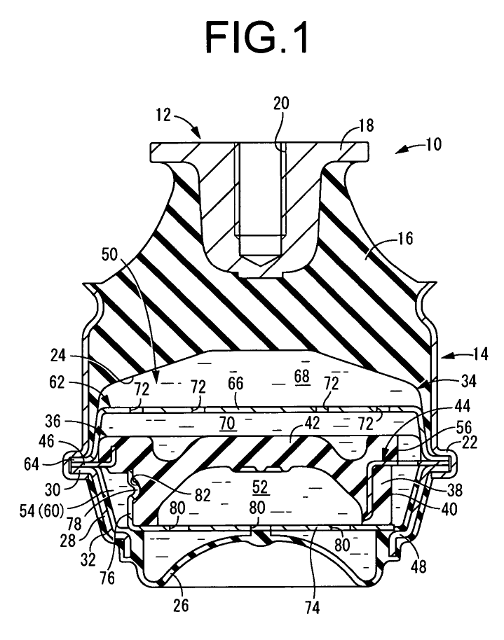

Referring first to FIG. 1, there is depicted an automotive engine mount 10 as a fluid filled type vibration damping device pertaining to a first embodiment of the invention. This engine mount 10 is composed of a first mounting member 12 of metal and a second mounting member 14 of metal, which are elastically connected by a main rubber elastic body 16. While not shown in the drawing, the first mounting member 12 is attached to the power unit side, while the second mounting member 14 is attached to the body side of an automobile, so that the power unit is supported in vibration-damping manner on the vehicle body. In the description hereinbelow the vertical direction shall as general rule refer to the vertical direction in FIG. 1, which represents the approximately vertical direction of the installed mounting, as well as the direction of input of principal vibration load.

More specifically, the first mounting member 12 has a generally circular block shape with an integrally formed flange portion 18 spreading diametrically outward at its axial upper end. A bolt hole 20 that opens upward is formed along the center axis of the first mounting member 12, and the first mounting member 12 is fastened to the power unit of the automobile, not shown, by means of a fastening bolt threaded into this bolt hole 20.

The second mounting member 14 has a large diameter, generally round tubular shape, with a caulking portion 22 that spreads diametrically outward being formed at an opening at its axial lower end. The first mounting member 12 is positioned co-axially with and above the second mounting member 14 with an axial spacing therebetween. The first mounting member 12 and the second mounting member 14 are elastically linked by means of the main rubber elastic body 16.

The main rubber elastic body 16 has a generally frustoconical shape overall, with a large-diameter recess 24 opening axially downward being formed on its large-diameter end face. The first mounting member 12 is bonded by vulcanization to the small-diameter end face of the main rubber elastic body 16, while the second mounting member 14 is vulcanization bonded to the outside peripheral face of the large-diameter end. That is, the opening at the axial upper end of the second mounting member 14 is sealed off by the main rubber elastic body 16. The first mounting member 12, having been inserted into the main rubber elastic body 16 from its small-diameter end face, is bonded by vulcanization over generally its entire face to the main rubber elastic body 16 with the exception of the axial upper end face. The second mounting member 14, having been disposed fitting externally about the outside peripheral face of the large-diameter end into the main rubber elastic body 16, is bonded by vulcanization over generally its entire face to the main rubber elastic body 16 with the exception of the caulking portion 22.

A diaphragm 26 serving as the flexible film is attached to the opening at the axial lower end of the second mounting member 14. This diaphragm 26 consists of a generally dome shaped thin rubber film imparted with slack so as to deform easily. A generally round tubular fastener fitting 28 is bonded by vulcanization at its axial lower peripheral edge to an outside peripheral edge of the diaphragm 26. A fastening flange 30 integrally formed on the axial upper peripheral edge of the fastener fitting 28 so as to spread diametrically outward therefrom is juxtaposed against the caulking portion 22 formed at the lower opening of the second mounting member 14 and caulked in place fluid-tightly to attach the diaphragm 26 to the opening at the axial lower end of the second mounting member 14. The opening at the axial lower end of the second mounting member 14 is thereby provided fluid-tight closure by the diaphragm 26. In this embodiment, the inside and outside peripheral faces of the fastener fitting 28 are covered substantially entirely by a thin coating rubber layer 32 integrally formed with the diaphragm 26.

With the opening at the axial upper end of the second mounting member 14 being covered fluid-tightly by the main rubber elastic body 16, and with the opening at the axial lower end of the second mounting member 14 being covered fluid-tightly by the diaphragm 26 as described above, there is formed between the opposing faces of the main rubber elastic body 16 and the diaphragm 26 a sealed zone 34 hermetically sealed from the outside. A non-compressible fluid is sealed within this sealed zone 34. The non-compressible fluid may be selected from water, an alkylene glycol, a polyalkylene glycol, silicone oil or other low-viscosity fluid having viscosity of 0.1 Pa•s or lower, in order to effectively attain vibration damping action based on resonance behavior of the fluid through a first orifice passage 60, to be described later.

A partition member 36 is disposed housed within the sealed zone 34 which contains the non-compressible fluid. This partition member 36 has a thick, generally disk shape overall, and is formed by a rubber elastic body. The outside peripheral section of the partition member 36 is particularly thick, and has an orifice forming portion 38 of annular block shape extending continuously with substantially unchanging cross section about the entire circumference. A notched circumferential groove 40 of rectangular cross section extending over a distance slightly less than once around the circumference is formed in this orifice forming portion 38, at its lower outside peripheral corner. Specifically, the notched circumferential groove 40 is divided by a septum portion (not shown) formed at one location on the circumferential, with the two circumferential ends of the notched circumferential groove 40 facing one another to either side of this septum portion.

The center portion of this partition member 36 constitutes a movable rubber plate portion 42 serving as a fluid pressure adjustment member (movable rubber). This movable rubber plate portion 42 has a disk shape of prescribed thickness with an outside peripheral edge of tapered shape sloping downward, giving it an inverted, generally bowl shape overall. The movable rubber plate portion 42 is disposed so as to extend in the axis-perpendicular direction within the center hole of the orifice forming portion 38, which constitute an integrally vulcanization molded component in which the outside peripheral face of the movable rubber plate portion 42 and the inside peripheral face of the axial medial portion of the orifice forming portion 38 are connected. That is, the center hole of the orifice forming portion 38 is sealed off fluid-tightly by the movable rubber plate portion 42.

A support fitting 44 having a thin annular plate shape overall is anchored to the partition member 36 so that its outside peripheral edge projects diametrically outward from the partition member 36 along the entire circumference, with the outside peripheral edge portion of the support fitting 44 constituting an anchoring portion 46. The section of the support fitting 44 situated in proximity to the two circumferential ends of the circumferential groove 40 extends axially downward, thereby reinforcing the section of the orifice forming portion 38 situated in proximity to the two circumferential ends of the circumferential groove 40.

The partition member 36 constructed in this way is housed within the sealed zone 34 containing the non-compressible fluid, arranged spreading in the axis-perpendicular direction at the lower opening of the second mounting member 14. The outside peripheral edge of the support fitting 44 (i.e. the anchoring portion 46) bonded by vulcanization to the partition member 36 is superposed against the caulking portion 22 of the second mounting member 14, and by means of the caulking portion 22 is secured caulked fluid-tightly against the lower opening of the second mounting member 14, together with the fastening flange 30 of the fastener fitting 28. That is, the partition member 36 is supported by means of the second mounting member 14.

With the partition member 36 secured caulked against the lower opening of the second mounting member 14, the lower end of the orifice forming portion 38 is superposed against a step portion 48 formed in the axially medial portion of the fastener fitting 28. In this embodiment, the coating rubber layer 32 coating the inside peripheral face of the fastener fitting 28 is fairly thick in the section thereof which covers the vicinity of the step portion 48. The lower end of the orifice forming portion 38 is then superposed against the annular juxtaposition face formed by this thick section. With this arrangement, the inner periphery side and the outer periphery side of the orifice forming portion 38 are partitioned fluid-tightly, and the upper side and lower side of the orifice forming portion 38 are partitioned fluid-tightly as well. As a result, the sealed zone 34 is partitioned top to bottom by the partition member 36.

By partitioning the sealed zone 34 top to bottom with the partition member 36, a pressure-receiving chamber 50 is formed to the upper side of the partition member 36, while an equilibrium chamber 52 is formed to the lower side of the partition member 36. A portion of the wall of the pressure-receiving chamber 50 is formed by the main rubber elastic body 16, and pressure fluctuations are produced in it when vibration is input. A portion of the wall of the equilibrium chamber 52 is formed by the diaphragm 26, and it readily permits change in volume so as to quickly dissipate pressure fluctuations.

By caulking the partition member 36 in the manner described above, an annular zone 54 is formed extending in the circumferential direction between the opposing faces of the orifice forming portion 38 and the fastener fitting 28 at a location radially outside of the sealed zone 34. This annular zone 54 is divided fluid-tightly at one location on the circumference by a septum portion, and thereby extends with substantially unchanging cross section over a distance slightly less than once around the circumference. The annular zone 54 at a first circumferential end thereof connects with the pressure-receiving chamber 50 via a communication hole 56, and at the other circumferential end thereof connects with the equilibrium chamber 52 via a through-hole (not shown). As a result, a first orifice passage 60 through which the pressure-receiving chamber 50 and the equilibrium chamber 52 communicate with each other is formed in the outside peripheral portion of the sealed zone 34, utilizing the partition member 36. In this embodiment, the first orifice passage 60 is tuned to the frequency band of engine shake. In this embodiment, therefore, the communication hole 56 connecting the annular zone 54 to the pressure-receiving chamber 50 is formed so as to extend in the vertical direction in the outside peripheral portion of the partition member 36 (the orifice forming portion 38). That is, in this embodiment, the first orifice passage 60 opens into the pressure-receiving chamber 50 at the outside peripheral portion of the partition member 36 (the orifice forming portion 38).

Also, by caulking the partition member 36 in the manner described above, the movable rubber plate portion 42 is arranged spreading in the axis-perpendicular direction within the sealed zone 34. With the movable rubber plate portion 42 arranged in this way, its upper face is subjected to the pressure of the pressure-receiving chamber 50, while its lower face is subjected to the pressure of the equilibrium chamber 52. The movable rubber plate portion 42 undergoes elastic deformation due to the pressure applied to it.

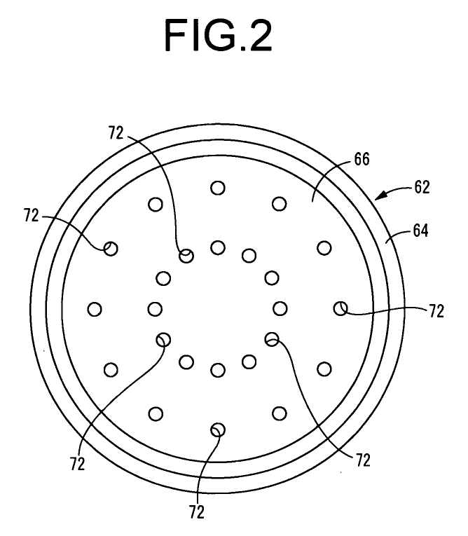

A septum member 62 is disposed housed within the sealed zone 34. As shown in FIG. 2, this septum member 62 has a shallow inverted cup shape overall, and is fabricated of rigid material such as metal, synthetic resin, or hard rubber. A flange portion 64 that projects diametrically outward is integrally formed at the lower opening of the septum member 62. The septum member 62 constructed in this manner is housed within the non-compressible fluid sealed zone 34, arranged spreading in the axis-perpendicular direction. The flange portion 64 is superposed against the caulking portion 22 of the second mounting member 14, with the caulking portion 22 secured caulked fluid-tightly against the lower opening of the second mounting member 14, together with the fastening flange 30 of the fastener fitting 28 and the anchoring portion 46 of the partition member 36.

With the septum member 62 fastened by caulking to the lower opening of the second mounting member 14, the upper base plate 66 of the septum member 62 is positioned between the opposing faces of the partition member 36 and the main rubber elastic body 16. With this arrangement, the pressure-receiving chamber 50 formed between the opposing faces of the partition member 36 and the main rubber elastic body 16 is partitioned by the septum member 62 into a main rubber elastic body 16 side and a partition member 36 side. As a result, a first pressure-receiving section 68 whose wall is partially defined by the main rubber elastic body 16 is formed above the upper base plate 66, while a second pressure-receiving section 70 whose wall is partially defined by the movable rubber plate portion 42 is formed below the upper base plate 66. Since the communication hole 56 is formed on the outside peripheral edge of the partition member 36 (the orifice forming portion 38), the first orifice passage 60 opens into the second pressure-receiving section 70. With this arrangement, the second pressure-receiving section 70 and the equilibrium chamber 52 are placed in communication with the first orifice passage 60.

As mentioned previously, a plurality (24 in this embodiment) of through-holes 72 are formed in the upper base plate 66 of the septum member 62 dividing the first pressure-receiving section 68 and the second pressure-receiving section 70.

In this embodiment, these through-holes 72 of generally constant circular cross section all penetrate the upper base plate 66 in its thickness direction. In this embodiment, the plurality of through-holes 72 are of the same size. However, the plurality of through-holes 72 could differ in size or shape as well. The size of the through-holes 72 is established appropriately depending on consideration such as the required vibration damping characteristics and the size of bubbles which form, but in preferred practice, they will have inside diameter dimension of 1 mm-10 mm. Where the inside diameter dimension is less than 1 mm, it is difficult for the sealed fluid to flow through the through-holes 72, possibly resulting in problems such as the need to form a very large number of through-holes 72. Where the inside diameter dimension exceeds 10 mm, on the other hand, there is a risk of difficulty in finely dispersing bubbles which have formed.

In this embodiment, the plurality of through-holes 72 are arranged so as to spread radially out from the center of the upper base plate 66. In particular, in this embodiment the plurality of through-holes 72 are distributed generally uniformly in the circumferential direction about the center axis of the upper base plate 66, so that there is no directionality along the circumference. Specifically, the through-holes 72 are divided into groups of twelve, arranged on two concentric circles. That is, in this embodiment, twelve through-holes 72 are arranged at equal intervals in the circumferential direction on one concentric circle, with the circumferential locations of the twelve through-holes 72 arranged on the inner concentric circle and the locations of the twelve through-holes 72 arranged on the outer concentric circle being identical to one another.

In this embodiment, since the plurality of through-holes 72 are formed in the upper base plate 66, where the septum member 62 is viewed as a whole, the plurality of through-holes 72 will appear to be formed in the center portion of the septum member 62. In this embodiment, the through-holes 72 formed on the outer concentric circle are positioned diametrically inward (inward in the axis-perpendicular direction) from the communication hole 56 (the portion of the first orifice passage 60 open to the second pressure-receiving section 70). That is, all of the through-holes 72 are formed peripherally inward from the communication hole 56, avoiding the area directly above the communication hole 56.

Through the plurality of through-holes 72 formed in the upper base plate 66 of the septum member 62, the first pressure-receiving section 68 communicates with the second pressure-receiving section 70, and the plurality of through-holes 72 constitutes a second orifice passage. This second orifice passage (72) is tuned to a higher frequency band than the first orifice passage 60. In this embodiment, the second orifice passage (72) is tuned to the frequency of idling vibration.

Additionally, in this embodiment, a plate fitting 74 is disposed so as to be superposed against the lower face of the partition member 36. This plate fitting 74 has a thin round disk shape overall, and at the outside peripheral edge thereof has upwardly projecting engaging claws 76 integrally formed at an appropriate number of locations along the circumference thereof. With engaging projections 78 furnished to the engaging claws 76 engaged by engaging recesses 82 the open onto the outside peripheral face of the orifice forming portion 38 of the partition member 36, the plate fitting 74 constructed in this way is attached to the second mounting member 14 by being clamped between the lower end face of the partition member 36 and the step portion 48 of the fastener fitting 28.

The plate fitting 74 attached to the second mounting member 14 is positioned between the opposed faces of the movable rubber plate portion 42 and the diaphragm 26, spaced apart from both of these and extending in the axis-perpendicular direction. With this arrangement, the equilibrium chamber 52 is divided by the plate fitting 74 into the upper and lower sides thereof. The upper and lower portions of the equilibrium chamber 52 are held in communication with each other through a plurality of through-holes 80 formed in the plate fitting 74. The first orifice passage 60 may open into either side of the plate fitting 74. In this embodiment, it opens into the movable rubber plate portion 42 side.

In the engine mount 10 constructed in this way, the first mounting member 12 is fastened to the power unit side by means of a fastening bolt threaded into the bolt hole 20, while the second mounting member 14 is fastened to the body side by means of a bracket or the like, thereby installing the engine mount 10 between the power unit and the body.

With the engine mount 10 installed in this fashion, when vibration is input across the first mounting member 12 and the second mounting member 14, fluid flow through the first orifice passage 60 is produced on the basis of a fluctuation in relative pressure between the pressure-receiving chamber 50 and the equilibrium chamber 52, and effective vibration damping is attained on the basis of the flow action of the fluid.

When large shocking vibration load is input across the first mounting member 12 and the second mounting member 14, a large change in fluid pressure is produced in the pressure-receiving chamber 50, bubbles form at the opening of first orifice passage 60 into the second pressure-receiving section 70, and these bubbles move towards the first pressure-receiving section 68. At this time, the bubbles pass through the through-holes 72 formed in the upper base plate 66 of the septum member 62 which divides the first pressure-receiving section 68 from the second pressure-receiving section 70, and move from the second pressure-receiving section 70 into the first pressure-receiving section 68.

With this arrangement, the formed bubbles are finely dispersed. As a result, it is possible to reduce the size of individual bubbles when they burst, and additionally to stagger the timing at which individual bubbles burst.

Consequently, the engine mount 10 of construction according to this embodiment, makes it possible to attain an overall reduction in noise and vibration caused by bursting of formed bubbles.

Also, in this embodiment, the plurality of through-holes 72 are arranged radially, i.e. not arranged biased towards a specific area (e.g. the vicinity of the opening of the first orifice passage 60 to the second pressure-receiving section 70 side). This makes it possible to attain stable flow of fluid caused to flow through the second orifice passage (72), as well as making it unlikely that the movement of formed bubbles to the first pressure-receiving section 68 side will be restricted. Additionally, since there is no need to consider mispositioning of the septum member 62 in the circumferential direction, when caulking the septum member 62, operability during septum member 62 assembly is improved.

Also, in this embodiment, the wall of the second pressure-receiving section 70 is partially defined by the movable rubber plate portion 42. This makes it possible to avoid high spring at frequencies higher than the tuning frequency of the first orifice passage 60.

In this embodiment, the second orifice passage is constituted by a plurality of through-holes 72 formed in the septum member 62 which divides the first pressure-receiving section 68 and the second pressure-receiving section 70, and the second orifice passage is tuned to a higher frequency band than the first orifice passage 60. Therefore, it is possible to obtain high vibration damping action based on resonance behavior of the fluid caused to flow through the second orifice passage (72) during input vibration of a higher frequency band than the tuning frequency of the first orifice passage 60.

Additionally, in this embodiment, since the second mounting member 14 is of tubular shape, it is possible to form the pressure-receiving chamber 50 and the equilibrium chamber 52 juxtaposed in the axial direction, and thereby to advantageously ensure space for forming the pressure-receiving chamber 50 and the equilibrium chamber 52.

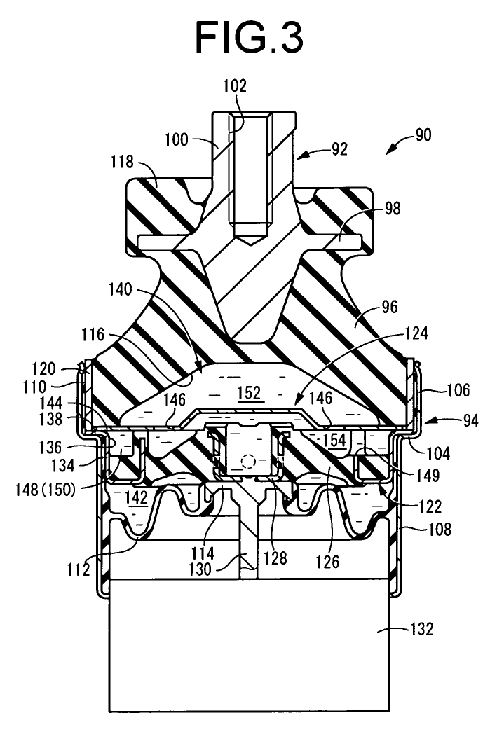

Next, a second embodiment of the invention will be described based on FIG. 3. FIG. 3 depicts an automobile engine mount 90 as the fluid vibration damping device of a second embodiment of the invention. This engine mount 90 comprises a first mounting member 92 of metal and a second mounting member 94 of metal, these being positioned in opposition spaced apart from one another and elastically linked by a main rubber elastic body 96 interposed between them. The engine mount 90 is installed with the first mounting member 92 mounted on the power unit (not shown) and the second mounting member 94 mounted on the automobile body (not shown), so that the power unit is supported in vibration damped fashion on the body. In this installed state, the engine mount 90 bears the distributed load of the power unit exerted across the first mounting member 92 and the second mounting member 94 in the direction of the center axis of the mounting (which is also the vertical direction in FIG. 3), so that the main rubber elastic body 96 undergoes elastic deformation in the direction such that the first mounting member 92 and the second mounting member 94 move closer together. The principal vibration intended to damp is also input in the direction of the two fittings 92, 94 moving closer together/further apart. In the description hereinbelow the vertical direction shall as general rule refer to the vertical direction in FIG. 3.

More specifically, the first mounting member 92 has an inverted frustoconical shape. A stopper portion 98 of annular plate shape projecting from the outside peripheral face is integrally formed at the large-diameter end of the first mounting member 92. A fastening shaft 100 integrally projects axially upward from the large-diameter end of the first mounting member 92, with a fastening screw hole 102 opening onto the upper end being formed in the fastening shaft 100. The first mounting member 92 is mounted onto the power unit of the automobile, not shown, by means of a fastening bolt (not shown) screwed into this fastening screw hole 102.

The second mounting member 94, on the other hand, has a large-diameter, generally tubular shape. A step portion 104 is formed in the axially medial portion of the second mounting member 94, with the side axially above this step portion 104 constituting a large-diameter portion 106 and the side axially below constituting a small-diameter portion 108. A thin seal rubber layer 110 is formed covering the inside peripheral face of the large-diameter portion 106. At the opening at the axial lower end of the second mounting member 94 is disposed a diaphragm 112 as the flexible film, consisting of a thin rubber film. By vulcanization bonding the outside peripheral edge of the diaphragm 112 to the rim of the opening on the axial lower side of the second mounting member 94, the opening on the axial lower side of the second mounting member 94 is provided with fluid-tight closure. A connector fitting 114 of generally inverted cup shape is formed in the center portion of the diaphragm 112.

The first mounting member 92 is disposed spaced apart axially above the second mounting member 94, with the first mounting member 92 and the second mounting member 94 elastically linked by means of the main rubber elastic body 96.

The main rubber elastic body 96 has a generally frustoconical shape overall, with a large-diameter recess 116 formed at the large-diameter end thereof. The first mounting member 92, inserted in the axial direction, is bonded by vulcanization to the small-diameter end of the main rubber elastic body 96. The stopper portion 98 of the first mounting member 92 is superposed against and bonded by vulcanization to the small-diameter end of the main rubber elastic body 96, and a strike rubber 118 projecting upward from the stopper portion 98 is integrally formed with the main rubber elastic body 96. A connector sleeve 120 is vulcanization bonded to the outside peripheral face of the large-diameter end of the main rubber elastic body 96.

The connector sleeve 120 bonded by vulcanization to the outside peripheral face of the main rubber elastic body 96 is fitted into the large-diameter portion 106 of the second mounting member 94, and the large-diameter portion 106 is subjected to a diameter-constricting process to affix the main rubber elastic body 96 fitting fluid-tightly into the second mounting member 94. With this arrangement, the opening at the axial upper end of the second mounting member 94 is covered fluid-tightly by the main rubber elastic body 96. As a result, in the interior of the second mounting member 94, a zone fluid-tightly isolated from the outside space is formed between the opposing faces of the main rubber elastic body 96 and the diaphragm 112, and a non-compressible fluid is sealed therein.

The non-compressible fluid sealed in this zone, may be selected from water, an alkylene glycol, a polyalkylene glycol, silicone oil or the like, for example. A low-viscosity fluid having viscosity of 0.1 Pa•s or lower is favorable in order to effectively attain vibration damping action based on resonance behavior of the fluid.

A partition member 122 and a septum member 124 are installed in the second mounting member 94, disposed between the opposing faces of the main rubber elastic body 96 and the diaphragm 112.

The partition member 122 has a support rubber elastic body 126 that spreads out with prescribed thickness, and an excitation plate 128 serving as a excitation member while constituting the fluid pressure adjustment member in this embodiment, is bonded by vulcanization to the center portion of this support rubber elastic body 126. The excitation plate 128 has a generally cup shape, and the outside peripheral edge thereof is vulcanization bonded to the inside peripheral edge of the support rubber elastic body 126.

An outside peripheral fitting 134 of annular shape is vulcanization bonded to the outside peripheral edge of the support rubber elastic body 126. A circumferential groove 136 is formed in this outside peripheral fitting 134, extending continuously in the circumferential direction. A flanged portion 138 that spreads diametrically outward is formed at the opening on the axial upper end of the outside peripheral fitting 134. The flanged portion 138 is superposed against the step portion 104 of the second mounting member 94, and held clasped between the step portion 104 and the connector sleeve 120. With this arrangement, the partition member 122 extends in the axis-perpendicular direction in the medial portion between the opposing faces of the main rubber elastic body 96 and the diaphragm 112, positioned supported by the second mounting member 94 and dividing the interior of the second mounting member 94 in two to either side in the axial direction. As a result, to the upper side of the partition member 122, there is formed a pressure-receiving chamber 140 whose wall is partially defined by the main rubber elastic body 96 and that gives rise to pressure fluctuations based on elastic deformation of the main rubber elastic body 96 during vibration input across the first mounting member. To the lower side of the partition member 122 is formed an equilibrium chamber 142 whose wall is partially constituted by the diaphragm 112 and that readily permits change in volume.

With the partition member 122 arranged in the manner described above, the excitation plate 128 is displaceably supported by the support rubber elastic body 126. The excitation plate 128 is also affixed to the connector fitting 114. An actuator rod 130 fixed to the connector fitting 114 undergoes displacement actuated by an electromagnetic actuator 132 serving as the exciting device, producing excited displacement of the excitation plate 128. As the electromagnetic actuator 132, it is possible to employ any of those known in the art, and a detailed description will not be provided here. The electromagnetic actuator 132 can be fastened by means of a bracket, described later.

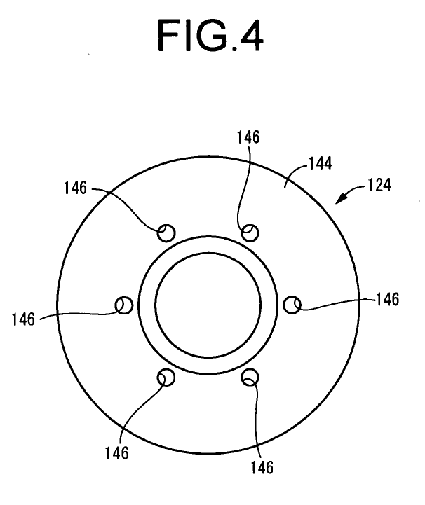

As depicted in FIG. 4, the septum member 124 has an overall shape resembling a shallow bowl turned upside down, and is fabricated of metal, synthetic resin, hard rubber or other such hard material. A flange portion 144 that projects diametrically outward is formed around the entire circumference at the lower opening of the septum member 124. A plurality of through-holes 146 (six in this embodiment) are formed in the inside peripheral edge of the flange portion 144.

In this embodiment, the plurality of through-holes 146 are situated at equal intervals in the circumferential direction. In this embodiment, each of the plurality of through-holes 146 is formed so as to perforate the flange portion 144 in its thickness direction, with a circular cross section. In this embodiment, the plurality of through-holes 146 are of the same size. The diameter of the through-holes 146 is not limited in any particular way, provided it is smaller than the size of the bubbles which form, and is set to within a range similar to the first embodiment. In this embodiment, the through-hole 146 diameter is 4 mm. In this embodiment, since the plurality of through-holes 146 are formed in the insider peripheral edge of the flange portion 144, when the septum member 124 is viewed in its entirety, the plurality of through-holes 146 appear located in the center portion of the septum member 124.

The septum member 124 constructed in this manner is arranged with the flange portion 144 superposed against the upper face of the outside peripheral fitting 134, and together with the flanged portion 138 of the outside peripheral fitting 134 is fastened clamped between the step portion 104 and the main rubber elastic body 96. With this arrangement, the upper opening of the circumferential groove 136 of the outside peripheral fitting 134 is covered by the flange portion 144 of the septum member 124. As a result, there is formed a circumferential passage 148 that extends through the outside peripheral portion of the partition member 122 in the circumferential direction, over a distance just short of circling it completely. A first end of this circumferential passage 148 connects with the pressure-receiving chamber 140 through a communication hole 149, while the other end connects to the equilibrium chamber 142 through a communication hole (not shown). With this arrangement, there is formed a first orifice passage 150 interconnecting the pressure-receiving chamber 140 and the equilibrium chamber 142. The first orifice passage 150 is tuned to the low frequency band of engine shake, for example. In this embodiment, since the first orifice passage 150 is formed utilizing the circumferential groove 136 of the outside peripheral fitting 134 furnished in the outside peripheral portion of the partition member 122, the first orifice passage 150 opens into the pressure-receiving chamber 140 at the outside peripheral edge of the partition member 122.

By disposing the septum member 124 between the partition member 122 and the main rubber elastic body 96 in the manner described above, the pressure-receiving chamber 140 formed between the opposing faces of the main rubber elastic body 96 and the partition member 122 is divided in two parts, into a main rubber elastic body 96 side and a partition member 122 side. There are formed thereby a first pressure-receiving section 152 whose wall is partially defined by the main rubber elastic body 96, and a second pressure-receiving section 154 whose wall is partially defined by the support rubber elastic body 126 and the excitation plate 128. In this embodiment, since the flange portion 144 of the septum member 124 is superposed against the partition member 122, the first orifice passage 150 connects with the second pressure-receiving section 154. With this arrangement, the second pressure-receiving section 154 and the equilibrium chamber 142 communicate with one another through the first orifice passage 150. In this embodiment, the opening of the first orifice passage 150 into the second pressure-receiving section 154 side (the communication hole 149) is located diametrically outward from the through-holes 146 formed in the septum member 124.

The first pressure-receiving section 152 and the second pressure-receiving section 154 communicate with one another through the plurality of through-holes 146 formed in the septum member 124, with a filter orifice serving as a second orifice passage being formed by the plurality of through-holes 146. The filter orifice is tuned to a higher frequency band than the frequency band of the vibration to be damped. Specifically, where it is desired to produce dynamic vibration damping action against idling vibration or driving rumble through excited displacement of the excitation plate 128 by the electromagnetic actuator 132, the filter orifice (through-holes 146) will be tuned to a frequency band slightly higher than driving rumble. With this arrangement, it is possible to advantageously avoid the pressure fluctuation component of the frequency band higher than the tuning frequency band being transmitted from the second pressure-receiving section 154 to the first pressure-receiving section 152 and a drop in vibration damping ability, when the excitation plate 128 undergoes excited displacement.

The engine mount 90 constructed in the above manner is installed with the first mounting member 92 mounted on the power unit as described previously, and the second mounting member 94 inserted fitting into a bracket (not shown) and mounted onto the body of an automobile, not shown, via the bracket.

In the engine mount 90 constructed in the above manner, it is possible to control flow of electrical current to a coil (not shown) provided to the electromagnetic actuator 132. Specifically, flow of electrical current to the coil can be controlled, for example, by carrying out adaptive control or other feedback control using the engine ignition signal of the power unit as a reference signal and the vibration detection signal of the component to be damped as an error signal, or by utilizing map control based on control data established in advance. With this arrangement, the excitation plate 128 can be subjected to actuating force corresponding to vibration to be damped, to achieve dynamic vibration damping action through internal pressure control of the pressure-receiving chamber 140.

The engine mount 90 of this embodiment as well has a plurality of through-holes 146 formed in the septum member 124 which divides the first pressure-receiving section 152 from the second pressure-receiving section 154, and therefore affords effects similar to the first embodiment in the event that large shocking vibration load is input across the first mounting member 92 and the second mounting member 94, resulting in a large change in fluid pressure within the pressure-receiving chamber 140 and the occurrence of bubbles at the opening of the first orifice passage 150 towards the second pressure-receiving section 154 side.

While the present invention has been described in detail in its presently preferred embodiment, for illustrative purpose only, it is to be understood that the invention is by no means limited to the details of the illustrated embodiment, but may be otherwise embodied.

For example, the shape of the septum member and the number, size, and locations of the through-holes formed in the septum member are not limited to those taught in the first and second embodiments herein.

Also, the shape and tuning frequency of the first orifice passage is not limited to that taught in the first and second embodiments herein. Nor is the shape and tuning frequency of the second orifice passage is not limited to that taught in the first and second embodiments herein.

In the first embodiment hereinabove, the fluid pressure adjustment member is constituted by movable rubber of plate shape spreading in the axis-perpendicular direction with respect to the second mounting member 14. This movable rubber is fixedly supported at its outside peripheral edge with respect to the second mounting member, and exhibits fluid pressure absorbing function by means of displacement based on elastic deformation of its center portion. However, this could be replaced with a fluid pressure adjustment member constituted by a movable plate displaceably positioned a small prescribed distance from the second mounting member. That is, there can be employed a mechanism whereby a movable plate consisting of a rigid plate element is supported displaceably in its entirety, with fluid pressure in the pressure-receiving chamber escaping on the basis of displacement thereof.

The excitation member could be composed of an excitation rubber plate or the like that permits displacement through elastic deformation.

In the second embodiment hereinabove, an electromagnetic actuator 132 is employed as the excitation means, but it would be possible to instead employ a pneumatic actuator as the excitation means.

Additionally, whereas the first and second embodiments describe specific examples of the invention implemented in an automotive engine mount, the invention can be implemented advantageously in automotive body mountings, or vibration damping devices for use in devices of various kinds besides automobiles.

It is also to be understood that the present invention may be embodied with various other changes, modifications and improvements, which may occur to those skilled in the art, without departing from the spirit and scope of the invention defined in the following claims.

What is claimed is:

1. A fluid filled type vibration damping device comprising:
a first mounting member;
a second mounting member;
a main rubber elastic body elastically connecting the first and second mounting members;
a pressure-receiving chamber whose wall is partially defined by the main rubber elastic body, and having a non-compressible fluid sealed therein;
an equilibrium chamber whose wall is partially defined by a flexible film, and having the non-compressible fluid sealed therein;
a first orifice passage through which the pressure-receiving chamber and equilibrium chamber communicate with each other; and
a rigid septum member partitioning the pressure-receiving chamber into a first pressure-receiving section and a second pressure-receiving section, with the first pressure-receiving section being partially defined by the main rubber elastic body, and the second pressure-receiving section being partially defined by a displaceable fluid pressure adjustment member,
wherein the first orifice passage is open to the second pressure-receiving section of the pressure-receiving chamber so that the second pressure-receiving section communicates with the equilibrium chamber through the first orifice passage, while the second pressure-receiving section communicates with the first pressure-receiving section through a plurality of through-holes formed through the septum member, and the plurality of through-holes constituting a second orifice passage tuned to a higher frequency band than the first orifice passage.

2. A fluid filled type vibration damping device according to claim 1, wherein the fluid pressure adjustment member comprises a movable rubber disposed so as to be elastically deformable with respect to the second mounting member.

3. A fluid filled type vibration damping device according to claim 1, wherein the fluid pressure adjustment member comprises a displaceably arranged excitation member, and an exciting device is provided for the purpose of exciting actuation of the excitation member.

4. A fluid filled type vibration damping device according to claim 1, wherein the first orifice passage is tuned to an engine shake frequency band, while the second orifice passage is tuned to a frequency band ranging from an idling vibration frequency to a booming noise frequency.

5. A fluid filled type vibration damping device according to claim 1, wherein the second mounting member is a tubular body that has a first opening arranged on a side of the first mounting member and provided with a fluid-tight closure by means of the main rubber elastic body, and has an other opening provided with a fluid-tight closure by means of the flexible film, and wherein a partition member is disposed between opposing faces of the main rubber elastic body and the flexible film and supported by the second mounting member to thereby form the pressure-receiving chamber on one side thereof while forming the equilibrium chamber on an other side thereof, and wherein the partition member is utilized to form the first orifice passage, and the first orifice passage opens onto the pressure-receiving chamber at an outside peripheral edge of the partition member, while the through-holes constituting the second orifice passage are formed in a center portion of the septum member.
